(19) United States
(12) Patent Application Publication
(10) Pub. No.: US 2004/0120483 A1
(43) Pub. Date: Jun. 24, 2004

(54) Telephonic interface for a visual presentation of a hierarchy of menus

(75) Inventor: J. M. Buzbee, Mineral Wells, TX (US)

Correspondence Address: CARR LAW FIRM, L.L.P., 670 FOUNDERS SQUARE, 900 JACKSON STREET, DALLAS, TX, 75202, US

(73) Assignee: J. M. Buzbee Family Limited Partnership, Mineral Wells, TX (US)

(21) Appl. No.: 10/326,623

(22) Filed: Dec. 20, 2002

(51) Int. Cl. H04M 11/00

(52) U.S. Cl. 379/93.17

(57) ABSTRACT

The present invention provides for a telephone caller response and option selection. An interface system provides to a telephone caller a visual representation of a hierarchy of one or more menus. A caller phone is employable to select at least one option from the visual representation of a hierarchy of menus provided by the telephone interface system. A caller computer is employable to receive the visual representation of a hierarchy of menus from the interface system. A caller monitor is employable to display the visual representation of a hierarchy of menus, thereby avoiding the more time consuming presentation of the hierarchy of menus in an oral fashion.

### TECHNICAL FIELD

The invention relates generally to a telephone system and, more particularly, to a telephone system providing caller options in one or more visual menus or other representations.

### BACKGROUND

Telecommunications is becoming increasingly important in the modern world and workplace. However, providing an individual to interact with a caller is costly. More and more businesses, government agencies and other content providers are therefore eliminating receptionists and a human operator. An automated telephone system can instead be employed to interface with the caller. These interfaces typically employ a menu having a plurality of hierarchy levels. In other words, a choice of “a,” “b” or “c” can each lead to a further plurality of choices.

Typically, in conventional telephonic interface systems, an oral communication is made to the caller, with all of the possible choices orally disclosed, after which a choice can be made by the caller. This generally leads to another sequence of choices. This choosing of menu selections in the hierarchy can go on for a number of levels before the caller arrives at the choice of interest. This can be time-consuming and generally frustrating to the caller. Furthermore, the oral presentation can also contain commercial, instruction and cautionary messages which can also slow the process of menu item selection. However, even if the caller eventually interacts with a human operator instead of interacting with prompts from a computer system, typically the caller has navigated through a lengthy menu of choices, most of which are not relevant to the caller's interest.

Therefore, a presentation of telephonic hierarchical selections is needed that overcomes some of the shortcomings of conventional presentations of telephonic hierarchical selections.

### SUMMARY

The present invention provides for a telephone caller response and option selection. An interface system provides to a telephone caller a visual representation of a hierarchy of one or more menus. A caller phone is employable to select at least one option from the visual representation of a hierarchy of menus provided by the telephone interface system. A caller computer is employable to receive the visual representation of a hierarchy of menus from the interface system. A caller monitor is employable to display the visual representation of a hierarchy of menus.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 schematically depicts a system for obtaining and display of a visual representation of a hierarchical menu; and

FIG. 2 is a Nodal Analysis diagram illustrating a signal flow from a calling phone requesting a visual hierarchical representation of menus.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electro-magnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combination thereof. In a preferred embodiment, however, the functions are performed by a processor, such as a micro-processor, a desktop computer or a mainframe in accordance with code, such as computer program code, software, and/or integrated circuits that are coded to perform such functions, unless indicated otherwise.

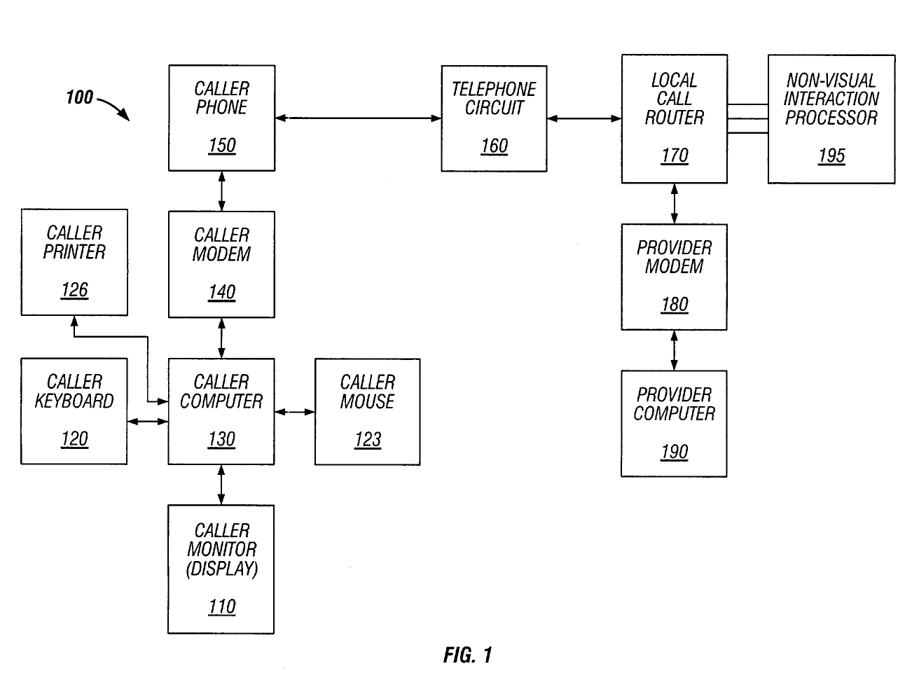

Referring to FIG. 1, the reference numeral 100 generally designates a telephonic system 100. Generally, the system 100 visually presents a hierarchy of menus and menu selections to a caller. This visual presentation of a hierarchy of menus generally enables the caller to evaluate the options and select the appropriate menu choice, or take other appropriate action, without the delay in receiving the options, and negotiating the hierarchy of menus, necessitated by an oral presentation of the menu options. In other words, the caller can visually see an option as a leaf node of a menu decision tree, and react appropriately, without the caller having to wait until being presented with the appropriate option orally.

The system 100 comprises a caller phone 150 and a caller modem 140. The caller modem 140 is coupled to a caller computer 130. The caller computer 130 is coupled to a caller keyboard 120, a caller monitor 110, a caller printer 126, and a caller mouse 123.

The system 100 further comprises a provider computer 190 coupled to a provider modem 180. The provider modem 180 is coupled to a local call router 170. In one embodiment, the local call router 170 is employable to route calls to a plurality of provider computers, personnel or other responders, at least one of which processes phone calls which do not request a visual representation of hierarchical menus, such as the non-visual interaction processor 195. The local call router 170 is coupled to a telephone circuit 160. The telephone circuit 160 can be circuit switched, packet switched, infrastructure for POTS (plain old telephone system), second or third generation (2G or 3G) mobile, and may also include light fiber, or other technologies understood by those of skill in the art. The telephone circuit 160 is connected to both the caller phone 150 and the local call router 170.

In the illustrated embodiment of FIG. 1, a phone call can be placed from the caller phone 150 to the telephone circuit 160 to the local router 170. The telephone circuit 160 adds a “ringing” signal to the phone call, which is discerned by the local call router 170.

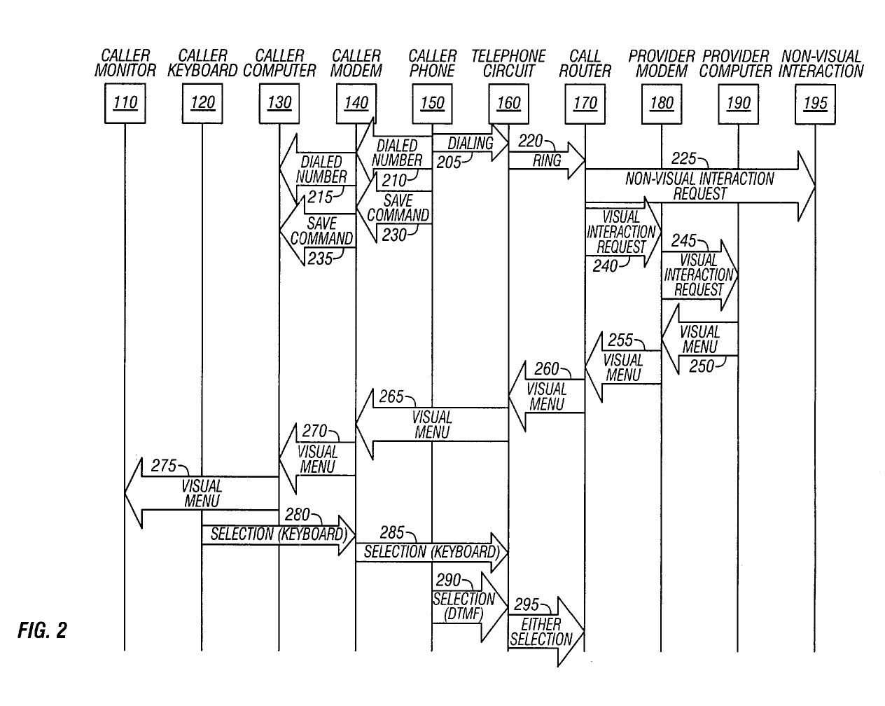

Upon the receipt of the ringing signal, the local call router 170 can send a brief greeting and a prompt for the alternative selection of either an audible or visual response to the caller employing the caller phone 150. In other embodiments, this selection of either an audible or visual response is associated with the original dialing flow 205, as shown in FIG. 2, and the local call router 170 does not send the prompt to select to the caller. In one embodiment, the selection is made by touch tone (DTMF) through employment of the caller. In another embodiment, the caller computer 130 is employable to, automatically or at the instigation of the caller, send a signal that the visual representation of hierarchical menus is to be presented to the caller. In a third embodiment, both the audible and the visual representation of hierarchical menus is to be presented without a selection of either mode by the caller.

If the conventional audible presentation menu is selected by the caller, non-visual interaction 195 menus are selected, and the oral presentation of menus over the caller phone 150 proceeds in a manner understood by those of skill in the art. However, if the caller selects the presentation menu to be a visual display menu, the local call router 170 accesses the provider modem 180 and the provider computer 190. The provider computer 190 then transmits a representation of the hierarchy of menus, or parts thereof, in digital form to the caller modem 140. The modem 140 then forwards the representation of the hierarchy of menus to the caller computer 130, and from there to the monitor display 110. The hierarchy of menus is then displayed visually for the caller, thereby allowing a faster recognition and selection of a menu option by the caller than if the hierarchy of menus were presented orally to the caller.

The caller then responds to the desired option. In one embodiment, the caller keyboard 120 is employed. In another embodiment, touch tone DTMF tones associated with the caller phone 150 are employed. In another embodiment, the caller mouse 123 is employed. In yet another embodiment, the caller gives oral directions based upon visual information that the caller perceives from the display monitor 110. However, those of skill in the art understand that there are other selection methods within the scope of the present invention. In one embodiment, the provider computer 190 and the provider modem 180 comprise an interface system for providing to a telephone caller a visual representation of a hierarchy of one or more menus, each menu having at least one option for selection.

In one embodiment of the system 100, provider software is employed to implement the recognition of a representation of a visual hierarchy of menus, at the request of the caller phone 150, by the provider computer 190. This software is employable in conjunction with the provider computer 190. The provider software employs a modem driver to establish the communication between provider modem 180 and the provider computer 190. The provider software can also enable the transmission of the representation of the visual hierarchy of menus from the provider computer 190 to the caller computer 130. In one embodiment, the representation of the visual hierarchy of menus comprises a computer file. The software also includes the ability to have the hierarchical menu structure adapted or replaced in the provider computer 190. The provider software can also provide protocols for error correction for transmissions between the provider computer 190 and the caller computer 130, proper disconnect procedures, reacting to hang ups by the caller, early selection by the caller, caller override, and so on.

Early selection can be generally defined as making a selection by the caller before the menu is received by the caller; for example, if a caller has prior knowledge of the menu to be presented. Therefore, the caller could make such a selection early, especially if the caller is placing the call through employment of a computer. This early selection can cause a program error from which the provider software must recover. Caller override can comprise overriding an invalid selection by the caller, errors created by the caller not responding within a predetermined length of time, or other events created by the caller or the system 100 that do not precisely follow the anticipated protocol.

In a further embodiment, the system further comprises caller software employable in conjunction with the caller computer 130. The caller software also generally recognizes the placement of a call, and also recognizes when the caller phone 150 selects the visual presentation of the hierarchy of menus. The caller software generally manages the caller modem 140 to transfer communications between the provider computer 190 and the caller computer 130. The caller software further allows for the caller computer 130 to receive and store the representation of the visual hierarchy of menus, and would also allow manipulation of this file, such as page-up, page-down, edit commands, and so on, and provide orderly recovery from errors and unusual commands or responses. Typically, the “edit” command would be used to make notes for future use in a stored menu or to delete unnecessary or undesirable content.

In a further embodiment, the caller phone 150, the caller modem 140, the caller computer 130, the caller keyboard 120, the mouse 123, and the caller monitor 110 are combined into a single device. In one embodiment, the single device comprises a wireless phone. In another embodiment, a “digital personal assistant,” such as a Palm Pilot®, with the caller software, performs the functionality of devices 110 through 150. In a further embodiment, at least some of the devices 110 through 150 are combined into a wired telephone. In a still further embodiment, two or more devices of 110 through 150 are combined into a unit that is employable with existing equipment the caller has for other purposes. For example, a wired telephone could also have a display integrated within that is employable for both the display of the hierarchy of menus and also for playing computer games.

In the system 100, in a still further embodiment, the transmittal of the visual hierarchy of menus is transparent to the caller. In other words, although the caller can be aware that the hierarchy is requested or presented through the telephone circuit 160 and the caller phone 150, the protocols or signaling energies employed to transmit and receive the visual hierarchy of menus do not pass a threshold of discernability of the senses of the caller.

In one embodiment, the telephone circuit 160 is employable to transmit 24 kilobits (KBs) per second when transmitting representations of a visual hierarchy of menus. At this speed, over 2000 characters per second can be transmitted from the provider computer 190 to the caller computer 130. In one embodiment, only text is transmitted, thereby limiting discomfort to the caller. Generally, the discomfort is caused by the time and sound similar to that of a computer linking up with an Internet provider.

Furthermore, there are “voice over data” methods available to make long transmissions, containing graphics, which are silent to the caller. Generally, “voice over data” is a term to describe the simultaneous transmission of voice and data over the same channel.

In a further embodiment, the caller computer 130 is employable to bypass the greeting that is transmitted by the local call router 170 when a call from the caller phone 150 is placed. The caller computer 130 instead automatically signals its presence to the local call router 170, and therefore to the provider computer 190, so transmission of the representation of the visual hierarchy of menus from the provider computer 190 can begin substantially immediately, with no further intervention on behalf of the caller to receive the representation of the hierarchy of menus required. The local call router 170 has software that allows it to either send the greeting to the caller phone 150 or pass the request for the visual representation of the hierarchy of menus on to the provider computer 190.

In a further embodiment, the caller and provider software allows both text and graphics to be transmitted so illustrations, banners, highlighting, and so on, can be transmitted and displayed. In one embodiment, a text editor is employable by the source computer 170 to navigate the hierarchy of menus and display graphics.

In a further embodiment, caller and provider software saves the received representation of the hierarchical menu of options and associates it with the called number when the number is redialed. Editing the file for comments by the caller, highlighting by the caller, and so on, is provided. Selective refresh can be available. In other words, the representation of the hierarchical menu structure is updated after a predetermined time, or when the provider computer 190 indicates that a newer version of the visual hierarchy of menus is now available.

Often, phone calls can be made to obtain data such as an account balance, another phone number or an email address. In one embodiment, the caller software and the provider software are configurable so that the request for such other data in digital and printable form is available by request from the caller keyboard 120, DTMF associated with the caller phone 150 or caller mouse 123. The printed form is output to the caller printer 126.

In another embodiment, once the called entity, such as the provider computer 190, detects the caller computer 130, the called entity displays a web site type style display to display the visual hierarchy of menus, or the actual web site of the called entity. In a further embodiment, there are forwarded connections to related web sites via the called entity's provided Hyperlink, and Internet connection in the visual presentation of the hierarchy of menus. In a yet further embodiment, the called entity responds with in yet other formats for the visual presentation of the hierarchy of menus.

Turning now to FIG. 2, a Nodal Analysis diagram illustrates a signal flow from a calling phone requesting a visual hierarchical representation of menus.

In flow 205, the caller phone 150 dials a call to the telephone circuit 160. The telephone circuit 160 then sends a ringing signal indicating a message or request to the local call router 170 in flow 220.

The local call router 170 determines whether the telephone call is a request for a visual representation of a hierarchy of menus, or whether the telephone call contains a request for an audio, that is, a non-visual, representation of menus. In an alternative embodiment, a greeting and/or prompt is sent to the caller phone 150 after the local call router 170 receives the call to determine whether the call is a request for a visual hierarchy of menus. If it is a request for a non-visual interaction, the router 170 sends a request to the non-visual interaction source 195 in flow 225, and the audio presentation of menus continues according to conventional non-visual representation technology.

However, if the telephone call contains a request for a visual interaction, this request is forwarded to the provider modem 180 in flow 240. Then, in flow 245, this request is further provided to the provider computer 190.

The provider computer 190 selects which visual menu or visual hierarchy of menus to send the caller, and then sends a digital representation of the menu back to the provider modem 180 in flow 250. The visual menu of hierarchy of menus (in digital form) is sent to the call router 170 in flow 255, and from there to the telephone circuit 160 in flow 260.

In flow 265, the digital information representing the visual hierarchical menu is sent to the caller modem 140. From the caller modem 140, in flow 270, the digital information is sent to the caller computer 130. The digital information is then processed by the caller computer 130, and transmitted to the caller monitor 110 in flow 275. In one embodiment, the modem 140 receives the dialed number as it is dialed and then forwards it to the caller computer 130 in flow 215, which saves it. Generally, saving the number enables the caller computer 130 to automatically recognize that a given dialed number is associated with a particular visual representation of hierarchical menus, thereby enabling its recall whenever the number is re-dialed, saving computer time to receive the digital information again. The save function also allows association of the file with other information, such as name, product, and so on, as well as the number.

In an alternative embodiment, the caller computer 130 can notify the local call router 170 that the dialed number is associated with a visual interaction request, thereby avoiding the time associated with the caller responding to a greeting from the local call router 170, or the time associated with the caller otherwise indicating to the local call router 170 of his or her choice of a visual interaction request. In a further embodiment, the local call router 170 is employable to select and send both the audible and visual data from the provider computer, without any selection or prompting at the caller end. The caller can then separate the desired information and discard the other information.

The caller can make the appropriate selection of a menu option after visually perceiving the visual hierarchical menu. In one embodiment, the keyboard data is first input through the caller computer 130 and then to the modem 140. This selection is then passed from the caller modem 140 to the telephone circuit 160. In a further embodiment, the caller can also employ the caller mouse 123.

In an alternative embodiment, the caller employs the caller phone 150 to convey menu selections through DTMF tones in data flow 290. However, the menu selections are chosen through the employment of the visual representation of hierarchical menus from the caller monitor 110. In either embodiment, the selections are forwarded back to the call router 170 in data flow 295.

It is understood that the present invention can take many forms and embodiments. Accordingly, several variations may be made in the foregoing without departing from the spirit or the scope of the invention.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

What is claimed is:

1. A system for providing a telephone caller response and option selection, comprising:
an interface system for providing to a telephone caller a visual representation of a hierarchy of one or more menus, each menu having at least one option for selection;
a caller phone employable to select at least one option from the visual representation of a hierarchy of menus provided by the telephone interface system;
a caller computer employable to receive the visual representation of a hierarchy of menus from the interface system; and
a caller monitor employable to display the visual representation of a hierarchy of menus.

2. The system of claim 1, further comprising a caller computer input device employable to respond to the display of the hierarchy of menus.

3. The system of claim 2, wherein the caller computer input device comprises a keyboard.

4. The system of claim 2, wherein the caller input device comprises a mouse.

5. The system of claim 1, further comprising a local call router interposed between the caller computer and the interface system.

6. The system of claim 5, wherein the local call router is employable to route calls configured for the visual presentation of the hierarchy of menus.

7. The system of claim 5, wherein the local call router is employable to route calls configured for the oral presentation of the hierarchy of menus.

8. The system of claim 1, further comprising a printer coupled to the caller computer.

9. The system of claim 1, wherein the caller phone, the caller monitor and the caller computer are integrated into one unit.

10. The system of claim 1, wherein the representation of the visual hierarchical menu structure comprises a computer file.

11. The system of claim 1, wherein the caller computer is employable to modify the presentation of the visual hierarchical menu structure.

12. The system of claim 1, wherein the caller computer is employable to perform a selective refresh upon the visual hierarchical menu structure.

13. The system of claim 1, wherein the caller computer is employable to associate a called number with a visual hierarchical menu structure.

14. The system of claim 1, wherein the interface system comprises a provider computer.

15. A method of telephonic communication, comprising:
transmitting an interaction request;
determining whether the interaction request is a visual or non-visual interaction request;
if the request is a visual interaction request, responding to the visual interaction request; and
if the request is a visual interaction request, transmitting a representation of a hierarchy of menus.

16. The method of claim 15, further comprising responding to the representation of the hierarchy of menus by the caller.

17. The method of claim 15, wherein the step of transmitting an interaction request is transmitted by the caller computer.

18. The method of claim 15, wherein the step of transmitting an interaction request is transmitted by the caller.

19. The method of claim 15, wherein transmitting a representation of a hierarchy of menus further comprises transmitting text and graphics.

20. A provider system for employment with transmitting a visual hierarchy of menus, comprising:
a local call router, configured to determine whether a call is a request for a visual interaction or a request for non-visual interaction;
a provider computer, configured to transmit a representation of a requested visual hierarchy of menus; and
a non-visual interaction provider, configured to transmit a requested non-visual representation of a hierarchy of menus.

21. A caller system for employment in requesting and receiving a visual hierarchy of menus, comprising:
a caller source, configured to request either a visual interaction or a non-visual interaction;
a caller computer, configured to receive the representation of the visual hierarchy of menus; and
a caller monitor, employable to display the visual hierarchy of menus.

22. The caller system of claim 21, further comprising a means for selecting an option within the visual hierarchy of menus.

23. The caller system of claim 21, wherein the visual interaction employs a visual hierarchy of menus.

24. The caller system of claim 21, wherein the caller source comprises a caller phone.

25. A system for providing caller response and option selection, comprising:
an interface system for providing to a caller both an oral and a visual representation of a hierarchy of one or more menus, each menu having at least one option for selection;
a display device for rendering to the telephone caller the visual representation of the hierarchy of menus; and
a caller response device employable to select at least one option in response to either the oral or the visual representation of a hierarchy of menus provided by the interface system.

26. The system of claim 25, wherein the response device comprises a telephone.
